(19) United States
(12) Patent Application Publication
(10) Pub. No.: US 2026/0209902 A1
(43) Pub. Date: Jul. 23, 2026

(54) Method For Manufacturing Billet And Aluminum Alloy Extruded Material

(71) Applicant: AISIN KEIKINZOKU CO., LTD., Imizu-shi (JP)

(72) Inventors: Karin SHIBATA, Imizu-shi (JP); Reina HAYASHIGAMI, Imizu-shi (JP)

(21) Appl. No.: 19/448,321

(22) Filed: Jan. 14, 2026

(30) Foreign Application Priority Data
Jan. 17, 2025 (JP) 2025-006883

(51) Int. Cl. C22C 21/10; C22F 1/053

(52) U.S. Cl. CPC C22C 21/10; C22F 1/053

(57) ABSTRACT

A method for manufacturing a billet comprising melting an aluminum alloy at 740° C. to 780 and casting the billet at a solidification rate of 5 ° C./sec or higher, the aluminum alloy including Zn: 6.0% to 8.0%, Mg: 1.0% to 2.0%, Cu: 0.10% to 1.0%, Zr: 0.10% to 0.25%, Ti: 0.005% to 0.05%, Si: 0.01% to 0.25% and Fe: 0.10% to 0.40%, Mn: 0.004% to 0.4% and Cr: 0.05% or less, a total of [Fe+ Mn+Cr+Zr] is within a range of 0.20% to 1.10%, a balance is Al and inevitable impurities, and as a raw material, a total of 30 mass% or more of a recycled material including scrap collected from a city and offsets or chips generated in manufacturing a product is contained, and homogenizing the billet at 470° C. to 540° C. and then cooling the billet at a cooling rate of 50 ° C./hr or higher.

### CROSS REFERENCE TO RELATED APPLICATIONS

This application is based upon and claims the benefit of priority to Japanese Patent Application No. 2025-006883 filed on Jan. 17, 2025, the entire contents of which are incorporated herein by reference.

### BACKGROUND OF THE INVENTION

The present disclosure relates to a 7000 series aluminum alloy, a method for casting a billet using the same, and a method for producing an extruded material.

From the viewpoint of the effective usage of aluminum resources, studies are underway to collect recycled materials that are collected from cities after used as aluminum products, offcuts, chips, and the like that are generated in steps of manufacturing aluminum products and reuse them as aluminum resources.

For example, extruded materials made of 7000 series aluminum alloys are in wide use as high-strength materials and are required to have not only bending workability for a variety of press machines, benders, and the like but also stress corrosion cracking resistance and the like to be used as parts for vehicles or aircrafts.

However, when recycled materials (scrap materials) collected from cities or offcuts, chips, and the like generated in the manufacturing steps are remelted and reused as aluminum resources, there is a technical problem in that the amount of an incorporated element referred to as an impurity, such as Si or Fe increases and quality characteristics, such as bendability, deteriorate.

For example, JP-A-2019-209362 discloses a technique of adding and adjusting a crystallization nucleus of an intermetallic compound that can be generated when molten aluminum solidifies for the purpose of preventing the coarsening of the intermetallic compound arising from an increase in the content of Fe.

However, the present technique is a technique applied to AC4C aluminum alloy castings, a carbide, such as TiC, is used as the crystallization nucleus, and a step of forming a primary crystal nucleus thereof is thus unstable, which is not practical.

JP-A-2010-116594 discloses an Al-Mg-Si-based aluminum alloy having excellent bendability.

However, this technique relates to a rolled material made of a 6000 series aluminum alloy, the proportion of an α phase crystallized substance in a β phase crystallized substance is used as a control line, and a control thereof is thus unstable, which is not practical.

### BRIEF DESCRIPTION OF THE DRAWINGS

FIG. 1 illustrates chemical compositions of aluminum alloys used in evaluations;

FIG. 2 illustrates conditions for manufacturing billets;

FIG. 3 illustrates conditions for manufacturing extruded materials;

FIG. 4 illustrates evaluation results of the extruded materials;

FIG. 5 illustrates a method for testing three-point bending; and

FIG. 6 illustrates an example of a nanostructural photograph of the extruded material.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or

letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between. An object of the disclosure is to provide an aluminum alloy for an extruded material having a

high strength and excellent bendability and stress corrosion cracking resistance, a method for manufacturing a cast billet using the same, and a method for manufacturing an extruded material. In accordance with one of some embodiments, an aluminum alloy for an extruded material contains, hereinafter by mass, Zn: 6.0% to 8.0%, Mg: 1.0% to 2.0%, Cu: 0.10% to 1.0%, Zr: 0.10% to 0.25%, and Ti: 0.005% to 0.05%, is allowed to further contain Si: 0.01% to 0.25% and Fe: 0.10% to 0.40%, and contains Mn: 0.004% to 0.4% and Cr: 0.05% or less, a total of [Fe+Mn+Cr+Zr] is within a range of 0.20% to 1.10%, a balance is Al and inevitable impurities, and as a raw material, a total of 30 mass% or more of a recycled material including scrap collected from a city and offsets or chips generated in manufacturing a product is contained.

The disclosure is characterized in that the amounts of other components are adjusted so that the amount of a Si component increased can be allowed up to 0.25% and the amount of an Fe component can be allowed up to 0.40% by the usage of a recycled material.

Here, as the scrap that is collected from a city, not only aluminum materials that are used as vehicle parts and aircraft parts but also aluminum materials that are widely used as wrought materials are included.

In addition, the offsets or chips that are generated in manufacturing a product may be offsets or chips that are generated during the cutting or bending of extruded materials. When the offsets or chips that are generated in manufacturing a product are included as an aluminum material, it is possible to effectively use aluminum materials other than the scrap that is collected from a city.

In accordance with one of some embodiments, 25 percent or more of the scrap that is collected from a city and 5% or more of the offsets or chips that are generated in manufacturing a product can be contained.

The disclosure is characterized not only in the chemical composition of the aluminum alloy but also a condition for manufacturing a billet.

In accordance with one of some embodiments, a method for manufacturing a billet for an extruded material has melting the above-referenced aluminum alloy at a temperature within a range of 740° C. to 780° C. and then casting a billet at a solidification rate of 5 ° C./sec or higher and homogenizing the billet at a temperature within a range of 470° C. to 540° C. and then cooling the billet at a cooling rate of 50 ° C./hr or higher.

When a billet is manufactured as described above, the amount of the Si component or the Fe component increases, whereby it is possible to suppress the coarsening of crystallized substances that are formed in a billet structure or the amount of the crystallized substances.

The average length of the crystallized substances that are formed in the metal texture of the billet manufactured as described above is 100 μm or less, and it is possible to suppress the area rate of the crystallized substances to 6% or less.

In accordance with one of some embodiments, a method for manufacturing an aluminum alloy extruded material comprises extruding the above-referenced billet at an extrusion ratio of 12 or higher, immediately thereafter, cooling an extruded material from a state of 400° C. to 550° C. to 200° C. or lower at a cooling rate within a range of 50 to 750 ° C./min, and a subsequent heat treatment including a first stage heat treatment at 80° C. to 130° C. and a second stage heat treatment at 135° C. to 170° C., wherein the total heat treatment time is 8 to 22 hours.

When an extruded material is manufactured as described above, the average length of crystallized substances that are generated in the metal texture of the extruded material is 20 μm or less, and the area rate of the crystallized substances reaches 6% or less. In addition, the PFZ width is 50 nm or more, and the number of precipitated particles that are precipitated on a line thereof per unit length of 1 μm reaches 10 particles/μm or less.

In the disclosure, a condition for die edge hardening immediately after the extrusion was controlled, was made to be slightly longer than a condition under which the intensity of an artificial aging treatment condition peaked, and was set to a sub/over aging condition.

The extruded material that is obtained in the disclosure is made of a 7000 series aluminum alloy and has excellent bendability or stress corrosion cracking resistance (SCC resistance) while having a high strength of a tensile strength of 400 MPa or higher and a 0.2% proof stress of 380 MPa or higher even when containing 25% or more, furthermore, 30% or more, of a recycled material.

Exemplary embodiments are described below. Note that the following exemplary embodiments do not in any way limit the scope of the content defined by the claims laid out herein. Note also that all of the elements described in the present embodiment should not necessarily be taken as essential elements.

An aluminum alloy composition that is applied to the disclosure will be described below.

### Zn

A Zn component is capable of increasing the strength without degrading the extrudability even at a high concentration; however, when the Zn component is added in a large amount, the stress corrosion cracking resistance deteriorates, and the content of Zn was thus set to a range of 6.0% to 8.0%.

### Mg

A Mg component is a most effective component for increasing the strength; however, when the Mg component is added in a large amount, the extrudability and the moldability deteriorate, and the content of Mg was thus set to a range of 1.0% to 2.0%.

### Cu

A Cu component is effective for increasing the strength by a solid solution effect; however, when the Cu component is added in a large amount, the extrudability, the corrosion resistance, and the moldability deteriorate, and the content of Cu was thus set to a range of 0.10% to 1.0%.

### Zr

Mn, Cr, and Zr are transition elements and are capable of suppressing the recrystallization depth on the surface of an extruded material during extrusion; however, when Mn, Cr, and Zr are added in a large amount, the hardening sensitivity is increased.

Among these, the Zr component can be sufficiently hardened by fan air cooling immediately after extrusion without strengthening the sensitivity compared with Mn and Cr, and the strength does not decrease.

In addition, when the content of Zr exceeds 0.25%, it is not possible to dissolve Zr in molten aluminum.

Therefore, the content of Zr was set to a range of 0.10% to 0.25%.

### Mn

A Mn component can be sufficiently hardened by fan air cooling without strengthening the sensitivity compared with Cr and is capable of satisfying both the stress corrosion cracking resistance and the strength.

In order to satisfy both the strength when the content of Mn is 0.30% or less and the suppression of recrystallization, Fe+Mn+Cr+Zr is preferably within a range of 0.20% to 1.10%.

### Ti

A Ti component is effective for refining crystal grains at the time of casting a billet for the extrusion of the aluminum alloy, and the content of Ti was set to a range of 0.005% to 0.05%.

### Fe and Si

The Fe and Si components are incorporated due to the use of the recycled material (scrap) as inevitable impurities in preparation of molten aluminum alloy and casting of the billet.

When the contents thereof become large, the strength, the corrosion resistance, and the moldability deteriorate.

Since Fe is capable of suppressing the recrystallization depth without strengthening the hardening sensitivity as a transition element, the content of Fe was set to a range of 0.10% to 0.40%, and the content of Si was set to a range of 0.01% to 0.25%.

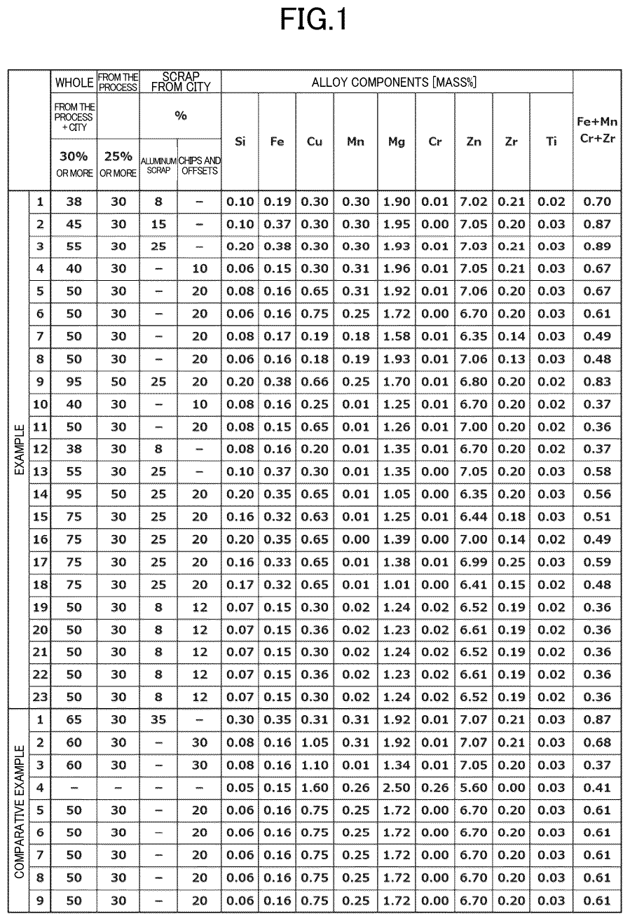

Next, billets were cast using molten aluminum alloys adjusted to have chemical compositions illustrated in FIG. 1, and physical properties thereof after extrusion and artificial aging treatments were evaluated, which will be described below.

“From the process” in FIG. 1 indicates the amounts of recycled materials containing offsets and chips that are generated in cutting and bending extruded materials of a 7000 series aluminum alloy, and “scrap from city” indicates the amounts of recycled materials, such as vehicle parts, aircraft parts, aluminum scrap, and chips and offsets collected from a city.

The total proportion of a recycled material from the process and a recycled material from a city that were fed into the entire molten aluminum was expressed as “whole.”

The recycled material from the process and the recycled material from a city were fed into the molten aluminum, and the remainder was made up of virgin material to adjust the composition.

In the disclosure, the usage rate of the recycled material from the process and the recycled material from a city is set to 30% or more as the whole. Among the whole, the target usage rates were set to 25% or more for the recycled material from the process and to 5 percent or more for the remaining recycled material from a city.

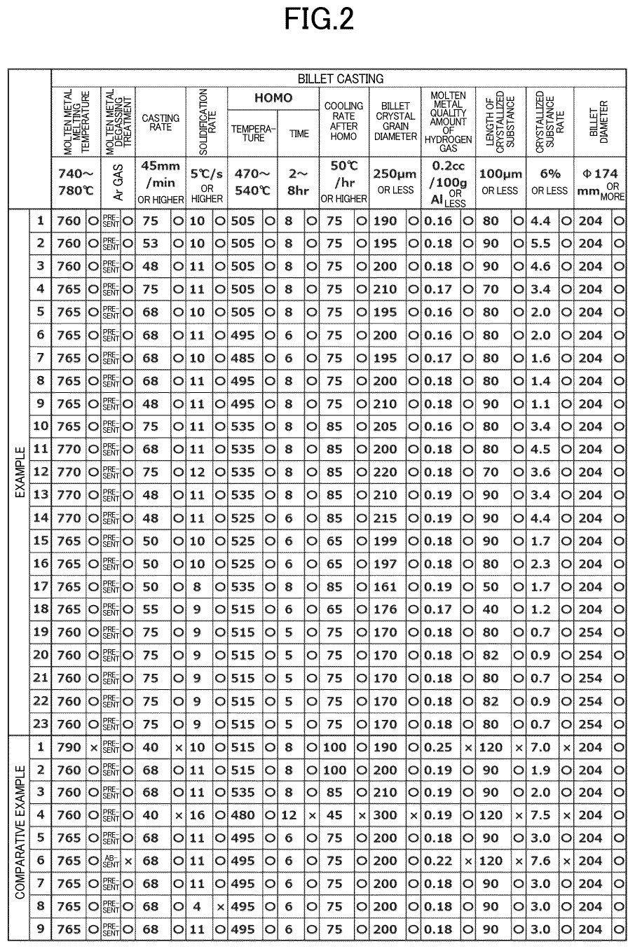

FIG. 2 illustrates conditions for casting billets.

In the present examples, billets having a diameter of 204 mm and billets having a diameter of 254 mm as billet diameters were cast.

The melting temperatures of molten metals were intended to be held to be within a range of 740° C. to 780° C., and specific holding temperatures are as illustrated in FIG. 2.

Hereinafter, specific examples are as illustrated in FIG. 2, and a target range will be described.

Molten metals were degassed by injecting an Ar gas thereinto, then, fed into a casting mold from the upper part, and cooled from the surroundings so that the solidification rates reached 5° C./sec or higher.

As a result, casting rates of 45 mm/min or higher can be obtained.

Homogenization treatments (HOMO) were performed on billets thus obtained.

In order to sufficiently form the solid solutions of precipitates, the homogenization treatments were preferably performed at 470° C. to 540° C. for 2 to 8 hours, and the cooling rates to near room temperature were set to 50 ° C./hr or higher to refine crystallized substances in the subsequent metal textures.

When the billets are thus manufactured, the average crystal grain diameters in the metal textures of the billets reach 250 μm or less, the average lengths of the crystallized substances reach 100 μm or less, and the area rates of the crystallized substances reach 6% or less.

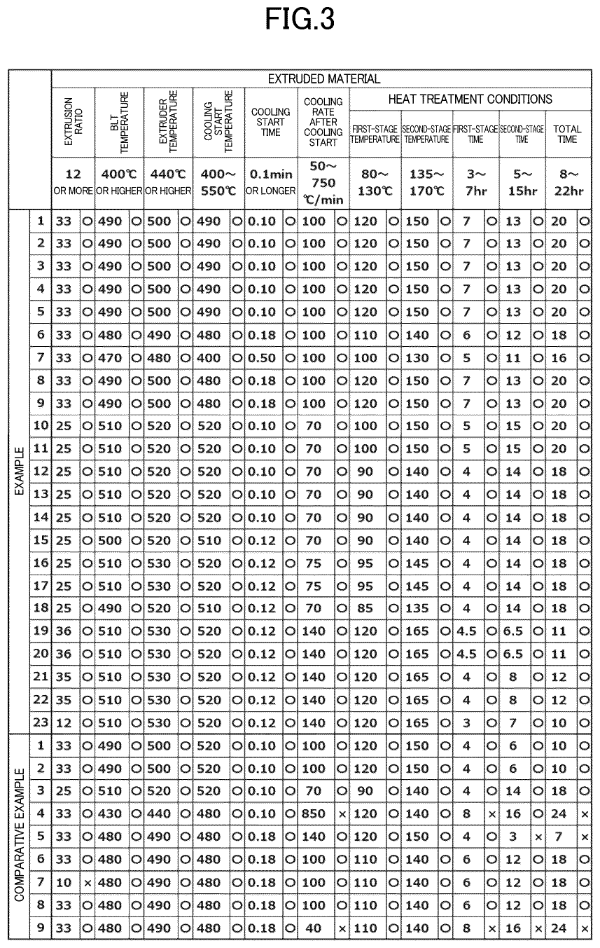

FIG. 3 illustrates conditions for processing extruded materials and heat treatment conditions.

Here, the extrusion ratio being 12 or more indicates values of the cross-sectional area of a billet/the cross-sectional area of an extruded material, when the extrusion ratio is high, the metal texture becomes fine, and the following die edge hardening becomes easy.

In addition, the heat treatment conditions are so-called two-stage artificial aging treatment.

In a first stage, primary crystals are precipitated at a relatively low temperature of 80° C. to 130° C. for 3 to 7 hours, after that, a second stage of heat treatment is performed at a relatively high temperature of 135° C. to 170° C. for 5 to 15 hrs, and precipitates are grown, thereby securing the strength.

At this time, in order to secure bendability, the conditions were set to sub/over aging conditions.

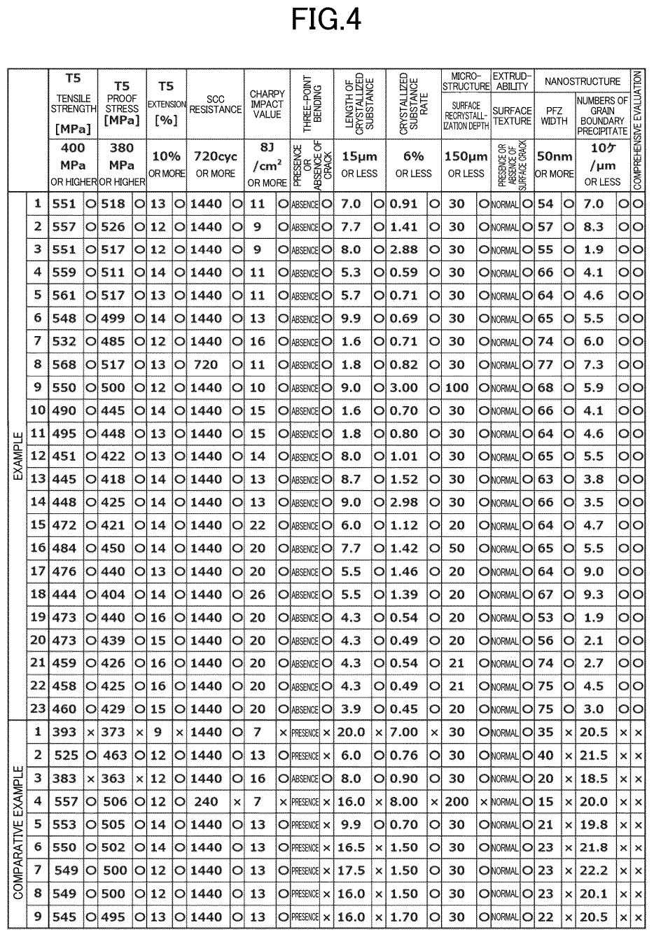

The physical property values of the extruded materials thus obtained are shown in the Table in FIG. 4.

Evaluation methods are as described below.

### Mechanical Characteristics

JIS 13B tensile test pieces were collected from the extruded materials, and tensile tests in accordance with JIS-Z2241 were performed.

### Three-Point Bending

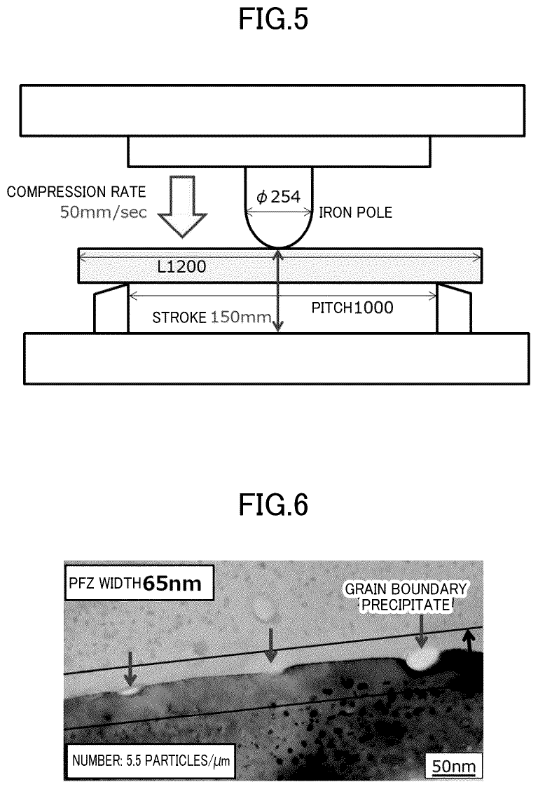

Test pieces having a length L of 1200 mm were cut out from the extruded materials, the extruded materials were supported at two points with a pitch of 100 mm therebetween as illustrated in FIG. 5 and compressed with an iron pole having a diameter of 254 mm from the center at a compression rate of 50 mm/sec up to a stroke of 150 mm using a compression testing machine (manufactured by Hodogayagiken Corporation), and the presence or absence of cracks in the appearances of the bent portions was evaluated.

### Charpy Test

JIS-V notch 4 test pieces were manufactured from the extruded materials based on JIS-Z2242, and Charpy impact tests were performed with a Charpy impact testing machine in accordance with JIS standards.

### Scc Resistance

Test pieces that were 3 mm in thickness t, 20 mm in width w, and 100 mm in length L were cut out from the extruded materials, and SCC resistance was evaluated by three-point bending stress load.

The following conditions with a stress of proof stress of 80% loaded on a test piece were defined as one cycle, test pieces in which cracks were not generated in the appearance until 720 cycles were evaluated as achieving a target (720 cyc or 1440 cyc), and for test pieces in which cracks were generated by then, the numbers of cycles (cyc) at which cracks were generated were used as evaluation values.

### One Cycle

A test piece is immersed in a 3.5% NaCl aqueous solution at 25° C. for 10 minutes, then, left to stand in a humidity of 40% for 50 minutes, and then naturally dried. Metal Textures

Samples were cut out from a central part (C), a radium ½ part (R/2), and a surface layer part (R) of a circular cross-section of the billet, mirror polishing finish is performed thereon, and etching is then performed with a Keller's reagent.

The metal textures were observed by optical microscope observation, the lengths of crystallized substances in the billet were measured from a 500× image and calculated as the average value.

The area rate of the crystallized substances in the 500× image was measured by image analysis.

### Microscopic Observation of Extruded Materials

Samples were cut out from the extruded materials, mirror polishing finish of extruded cross sections was performed, and the metal textures were then observed by optical microscope observation.

The lengths of the crystallized substances in the extrudate insides were measured from 1000× images and calculated as the average values.

The area rates of the crystallized substances in the 1000× images were measured by image analysis.

### Surface Recrystallization

Samples were cut out from the extruded materials, mirror polishing finish of extruded cross sections was performed, and etching was then performed with a sodium hydroxide reagent (3%NaOH).

The metal textures were observed by optical microscope observation, and the depths of recrystallized textures from the extruded surfaces were measured from 1000× images.

### Surface Texture

The surfaces of the extruded materials after extrusion were visually observed to check for the presence of foreign matter or cracks.

### Nanostructural Observation of Extruded Materials

Samples were cut out from the extruded materials, the extrudate insides were observed with a transmission electron microscope (TEM), and the PEZ widths (precipitate-free zones) of crystal grain boundaries were measured.

Samples were cut out from the extruded materials, the extrudate insides were observed with a transmission electron microscope (TEM), and the numbers of grain boundary precipitates present in the crystal grain boundaries per grain boundary unit length were measured.

In Examples 1 to 23, the die edge hardening immediately after extrusion is performed by air cooling, and it is possible to secure tensile strengths of 400 MPa or higher, 0.2% proof stresses of 380 MPa or higher, and extensions of 10% or more by the subsequent artificial aging treatments.

In the extruded materials thus obtained, the recrystallization depths from the surfaces are 150 μm or less, and appearance defects, such as cracks, on the surfaces are not generated.

In addition, in the metal textures of the extruded materials, the average lengths of the crystallized substances were 15 μm or less, and the area rates of the crystallized substances were 6% or less.

A photographic example of the nanostructure is illustrated in FIG. 6.

In the nanostructure, the PFZ width was 50 nm or more, and the number of particles precipitated on a line thereof was 10 particles/μm or less.

In addition, the bendability was evaluated by three-point bending, and it was possible to secure an impact value of 8 J/cm² or more with a Charpy testing machine.

The SCC resistance (stress corrosion cracking resistance) was also excellent so that no cracks were generated at 720 cyc or more.

In contrast to Examples 1 to 23, in Comparative Example 1, the content of the Si component was 0.30% that exceeded 0.25%, the temperature of the molten metal was also high, the tensile strength

and the proof stress were lower than target values, and cracks were generated even in the three-point bending.

In Comparative Example 2, since the content of the Cu component was 1.05% that exceeded 1.0%, the strength was high, but the bendability was poor.

In Comparative Example 3, the content of the Cu component was 1.10%, and the nanostructure failed to achieve the target, and the strength thus also slightly decreased.

In Comparative Example 4, since the content of Mg was 2.50% that was larger than 2.0%, and the casting conditions failed to satisfy the conditions, the strength was high, but the bendability and the SCC resistance were poor.

In Comparative Example 5, since the heat treatment time was short, the three-point bendability was poor, and in Comparative Example 6, since the degassing treatment was insufficient, the bendability was poor. In all of Comparative Example 7, Comparative Example 8, and Comparative Example 9, the bendability was poor since the extrusion ratio was low in Comparative Example 7, the solidification rate was slow in Comparative Example 8, and the cooling rate of the extruded material was slow in Comparative Example 9.

From these facts, it became clear that even when a total of 30% or more and a maximum of 95% of a recycled material is used, an extruded material having a high strength and excellent bendability and stress corrosion cracking resistance can be obtained by controlling the aluminum alloy, the method for manufacturing a billet, and the method for manufacturing an extruded material in the disclosure.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. A method for manufacturing a billet comprising,
melting an aluminum alloy at a temperature within a range of 740° C. to 780° C. and then casting the billet at a solidification rate of 5 ° C./sec or higher, the aluminum alloy including by mass:
Zn: 6.0% to 8.0%, Mg: 1.0% to 2.0%, Cu: 0.10% to 1.0%, Zr: 0.10% to 0.25%, and Ti: 0.005% to 0.05%;
being allowed to further contain Si: 0.01% to 0.25% and Fe: 0.10% to 0.40%;
containing Mn: 0.004% to 0.4% and Cr: 0.05% or less;
a total of [Fe+Mn+Cr+Zr] being within a range of 0.20% to 1.10%;
and a balance being Al and inevitable impurities,
wherein as a raw material, a total of 30 mass% or more of a recycled material including scrap collected from a city and offsets or chips generated in manufacturing a product is contained, and
homogenizing the billet at a temperature within a range of 470° C. to 540° C. and then cooling the billet at a cooling rate of 50 ° C./hr or higher.

2. The method for manufacturing a billet according to claim 1, wherein 25 percent or more of the scrap collected from a city and 5% or more of the offsets or chips generated in manufacturing a product can be contained.

3. The method for manufacturing a billet according to claim 1, wherein the billet is cast at a casting rate of 45 mm/min or higher.

4. A method for manufacturing an aluminum alloy extruded material, comprising:
extruding the billet according to claim 1 at an extrusion ratio of 12 or higher,
immediately thereafter, cooling an extruded material from a state of 400° C. to 550° C. to 200° C. or lower at a cooling rate within a range of 50 to 750 ° C./min, and
a subsequent heat treatment including a first stage heat treatment at 80° C. to 130° C. and a second stage heat treatment at 135° C. to 170° C., wherein the total heat treatment time is 8 to 22 hours.

5. The method for manufacturing an aluminum alloy extruded material according to claim 4, wherein an average length of crystallized substances that are generated in a metal texture of the extruded material is 20 μm or less, and an area rate of the crystallized substances reaches 6% or less.

6. The method for manufacturing an aluminum alloy extruded material according to claim 4, wherein PFZ (precipitate-free zones) width of crystal grain boundaries in the extruded material is 50 nm or more, and the number of precipitated particles that are precipitated on a line of the PFZ per unit length of 1 μm reaches 10 particles/μm or less.
